(19) United States
(12) Patent Application Publication
(10) Pub. No.: US 2018/0181903 A1
(43) Pub. Date: Jun. 28, 2018

(54) REAL-TIME BALANCE SHEET GENERATING SYSTEM, BALANCE SHEET EVALUATION SYSTEM, AND WORKING CAPITAL CIRCULATION VELOCITY EVALUATION SYSTEM

(71) Applicant: KOJIMA INDUSTRIES CORPORATION, Toyota-shi (JP)

(72) Inventors: Yoichiro KOJIMA, Toyota-shi (JP); Makoto KAWADA, Nagoya-shi (JP); Eiichi IHARA, Nagoya-shi (JP); Kenji KISHIDA, Nagoya-shi (JP)

(73) Assignee: KOJIMA INDUSTRIES CORPORATION, Toyota-shi (JP)

(21) Appl. No.: 15/630,402

(22) Filed: Jun. 22, 2017

(30) Foreign Application Priority Data
Dec. 22, 2016 (JP) 2016-249748

(51) Int. Cl. G06Q 10/08

(52) U.S. Cl. CPC G06Q 10/083; G06Q 10/0875

(57) ABSTRACT

A real-time balance sheet generating system includes a material flow tracking block for obtaining material flow information about each lot of an item in real time throughout processes from purchasing raw materials to shipping the product, a production data obtaining block for obtaining production data including a bill of materials (BOM) data and conversion process related data, a balance sheet storage block for storing a balance sheet as a reference, an immediate journal entry block for immediately and sequentially journalizing inventory assets related accounts in the material flow information obtained until a most recent moment, and a balance sheet update block for immediately and sequentially updating the balance sheet based on journalized results and for generating real-time balance sheet.

### CROSS-REFERENCE TO RELATED APPLICATIONS

This application claims the priority of Japanese Patent Application No. 2016-249748 filed Dec. 22, 2016, disclosure of which is incorporated by reference clearly and in its entirety, under 35 U.S.C. 119.

### BACKGROUND OF THE INVENTION

### 1.Field of the Invention

The present invention relates to a real-time balance sheet generating system, a balance sheet evaluation system, and a working capital circulation velocity evaluation system. Specifically, the invention relates to the real time balance sheet generating system for acquiring material flow information in real time throughout a process from purchasing raw materials to shipping product and instantly updates the balance sheet, the balance sheet evaluation system for evaluating quality of balance sheet, and the working capital circulation velocity evaluation system for evaluating supply-chain cash conversion cycle (SCCC).

### 2. Description of the Related Art

In view of net income distribution for the financial terms of listed companies, for example as shown in FIG. 15, a number of companies with a small deficit are extremely few. This proves a fact that listed companies give priority to an increase in short term profit in an income statement even at the expense of degrading the quality of a balance sheet in accordance with their values. An important point of manufacturing industry is “creating flow” which implies that material and money should flow smoothly without stagnation. That is, all processes including purchasing raw materials, production, shipment, receiving inspection, and payment are performed continuously without stopping. A problem here is that efforts for creating flow is, in accounting, not positively reflected in an income statement despite a short-term increase in the cash flow. In order to motivate creating flow efforts, focus of value in manufacturing management should be shifted from short-term profit to medium- to long-term profit, and the evolution in the efficiency of processing should be emphasized beyond financial results. Conventionally, in so-called “shareholder's value management”, the importance of short-term profit or loss in an income statement tended to be emphasized. Specifically, among three major financial reports, priority has been given to income statement, cash flow statement, and balance sheet in decreasing order. This priority should be changed into (1) balance sheet, (2) cash flow statement, and (3) income statement”. To this end, an accounting theory that regards medium- to long-term improvement of balance sheet quality as important is required. Further, information technology that validates such accounting theory is required.

Further, it is required to shorten the payment maturities, thereby speeding up the velocity of monetary flow in the total supply chain processes.

In order to “create flow”, values of a production system should be converted from “mass, make-to-stock” production (an efficient operation of management resources) to “limited, make-to-order” production (a necessary product is made when necessary). To this end, production lead time should be reduced. A means to solve this problem is “lead time-based overhead allocation (LTB)” that charges a total elapsed time (a lead time) including waiting time of materials (see Unexamined Japanese Patent Publication No. 2016-51223).

### BRIEF SUMMARY OF THE INVENTION

FIG. 1 illustrates a three tier conceptual model of management information system expressed as the layer structure to clarify the characteristics of management information in manufacturing enterprise. The first and second tiers mainly deal with information at a production site (Gemba), and the third tier mainly deals with information at headquarters. As mentioned above, when Gemba regards “creating flow” as an absolute must, headquarters must not pursue short-term profit in the income statement but should emphasize medium- to long-term profits and the improvement of the quality of the balance sheet. A kind of linkage of values between Gemba's must and headquarters' policy has not been established yet.

However, recently, techniques that enable to trace a material flow in real time, such as “Internet of Things” (IoT) have been developed. With IoT, by tracing a material flow in real time, transactions of material flow related accounts in the balance sheet (see FIG. 13) can be processed in real time by the realtime tracking processing, and as a result, “creating flow” status of production can be monitored in real time both at Gemba and Headquarters. As illustrated in FIG. 14, the balance sheet is not necessarily “stock” information. From wider perspectives, it is continuous “flow” information of raised capital and its usage flowing into liablities and assets, then flowing back into own capital. Through the process of the faster material and monetary flow, decrease of current assets (inventories) or accounts payable relatively to the amount of the total assets occurs, thus making the further increase of net property (profit) in future more feasible, which means the change of the structure of balance sheet for the better side. This is the concept of balance sheet quality (BSQ).

Further, in conventional fiscal cost accounting, traditional resource operation centered values explains the redundant resources created by the shorter lead time as the “operation loss”, which sounds like a bad news, although it is in reality a good news as the shorter lead time increase the cash flow and intensify competitive edge, thus resulting in the better BSQ.

Shifting the values of manufacturing system from mass, make-to-stock to limited, make-to-order production is not an easy job. In order to realize such conversion of values,

(1) Key performance indicators (KPI) should be shifted from “resource operation” oriented to the “material flow” oriented indicators.

(2) Degree of evolution should be constantly measured and visualised.

(3) New values and measures should be shared with by managers of the whole company.

In order to synchronize material flow and accounting process, information on material and monetary flows should be processed at the same time. For this purpose, information on transactions of sales and balance of payments, should be simultaneousely converted to the balance sheet that consists of the information about both material and monetary flows. Such conversions has become possible by means of recent progress of IOT.

Further, in order to create the faster flow, not only intra-, but also inter-company relationship must be taken into account, which serves the evolution of the global supply chain.

The embodiment of the present invention has been carried out in light of the above situation, the object of which is to provide the real-time balance sheet generating system, in which to acquire material flow information covering from purchase of materials to shipment of the product is acquired in real time and operating activities related information, and update the entire information as the real time balance sheet. The aim of the system is to measure and visualize the degree of flow speed of an entire supply chain to realize the faster flow of working capital supported by the better quality of the balance sheet (BSQ). BSQ defined in the system is the time length for the working capital to circulate through the entire supply chain.

According to an aspect of the present invention, a real-time balance sheet generating system includes:

(1) a material flow tracking block for obtaining material flow information about each lot of an item in real time throughout a process from purchasing raw materials to shipping the product;

(2) a production data obtaining block for accessing master files of production control system, and acquiring product-related data in a bill of materials (BOM) data and process-related data in a work-process master;

(3) a balance sheet storage block for storing a balance sheet as a reference;

(4) an immediate journal entry block for referring to the production data obtained by the production data obtaining block, and immediately and sequentially journalizing transactions that relate to assets-related accounts in the material flow information obtained by the material flow tracking block until a most recent moment; and

(5) a balance sheet update block implements for immediately and sequentially updating the balance sheet stored in the balance sheet storage block by adding the new entry to the most recent result in the immediate journal entry block, thus generating the balance sheet for that updated moment as a real-time balance sheet.

According to another aspect of the present invention, the real-time balance sheet generating system further includes an immediate indicator calculation block for immediate calculation of the balance sheet quality (BSQ) value that is a performance indicator expressed by following equation (1),

BSQ=(M+R)/A+N/C (1)

where M is inventory assets, R is accounts receivables, A is total assets excluding cash, N is accounts payables, and C is total liabilities and shareholder's equity.

According to another aspect of the present invention, the balance sheet update block journalizes an amount of increase or decrease in each of today's inventory amount against a balance of a previous day's balance sheet, and stores a journalized result in a daily transaction file, as today's updated material transaction data. The real-time balance sheet generating system further includes: (1) an operation transaction data obtaining block for obtaining today's purchase transaction data including today's occurrence and payment of accounts payable, today's sales transaction data including today's occurrence of accounts receivables and collection of price, and today's balance of payments data including today's deposit and withdrawal, and journalizing today's purchase transaction data, the today's sales transaction data, and the today's balance of payments data in accordance with on each of their own accounts to store a journalized result in the daily transaction file, as today's material transaction data; (2) a today's transaction journal entry block for journalizing the today's material transaction data and the today's operating transaction data stored in the daily transaction file, and storing journalized results in a today's trial balance transaction file; and (3) a today's financial statements generating block for generating a today's balance sheet, a today's income statements, and a today's cash flow statement respectively as financial reports of the day based on journal entry stored in the today's trial balance transaction file.

According to another aspect of the present invention, the real-time balance sheet generating system, further includes a today's performance indicator calculation block that calculates a performance indicator supply-chain cash conversion cycle (SCCC) based on the financial reports of the day, which is expressed by following equation (2),

SCCC=(M/Cₛ+R/S+P/Cₛ)·D (2)

where M is inventory assets, Cₛ is cost of goods sold, R is accounts receivables, S is sales, P is accounts payables, and D is an annual number of days.

According to another aspect of the present invention, the real-time balance sheet generating system further includes a financial statements conversion block that can convert the today's financial statements into financial statements based on each of predetermined financial accounting standards.

Another aspect of the present invention provides a balance sheet evaluation system for calculating, based on an introduced balance sheet, balance sheet quality (BSQ) that is a performance indicator and is expressed by following equation (1),

BSQ=(M+R)/A+N/C (1)

where M is inventory assets, R is accounts receivables, A is total assets excluding cash, N is accounts payables, and C is total liabilities and shareholder's equity.

Another aspect of the present invention provides a working capital circulation velocity evaluation system for calculating, based on introduced balance sheet and income statement, a supply chain cash conversion cycle (SCCC) that is a performance indicator and is expressed by following equation (2),

SCCC=(M/Cₛ+R/S+P/Cₛ)·D (2)

where M is inventory assets, Cₛ is cost of goods sold, R is accounts receivables, S is sales, P is accounts payables, and D is annual number of days.

The real-time balance sheet generating system according to the embodiment of the present invention acquires the information of all the processes of material flows from the process of purchasing raw material to the shipment of the product in terms of each individual item and lot number by tracking them in real time, and by immediate and automatic journal entry, instantly updates the balance sheet. In addition, by simply linking with the existing IoT system and production control system, the information cost to build this system is relatively low.

The immediate indicator calculation block that instantly calculates the performance indicator BSQ according to the above-mentioned equation (1) is able to update and visualize the BSQ value corresponding from moment to moment. The purpose of this performance indicator balance sheet quality (BSQ) is to evaluate the degree of evolution in creating flow and the improvement of productivity by means of the balance sheet, thereby let enabling management thinking swiftly shift from “preference to the income statement” to “preference to the balance sheet”. Especially in the early stage of shifting from mass, make-to-stock production to limited, make-to-order production for the shorter lead time, amount of profit fall is seemingly serious so that profit rate related indicators such as Return on Equity (ROE) considerably aggravates (see FIG. 12), which, in fact, is a good news of cash flow increase, which often confuses judgment of financial institutions, capital market and even managers themselves. Even in such situation, the decrease of BSQ value is a solid proof that the company's profitability and productivity has improved despite the profit fall in the income statement.

The Balance sheet update block, by being linked with the “Operation transaction data obtaining block”, “today's transaction journal entry block” and “Today's financial statements generating block” generates and visualizes the major three financial reports through automatic journal entry made by matching “today's material transaction data” that accrues in today's material flows with “today's operating transaction data” that accrues in today's monetary flows. This system can be built with relatively low information cost by using existing purchase system, sales system and accounting system etc.

Accounts of these generated financial reports are all recorded by acquisition costs expressed by entrance price so that today's earned net profit as the gap between the previous day's net assets and today's net assets can be measured every day. Further, so far, traditional accounting system of many private enterprises could not generate the cash flow from operating activities by the “direct” method (in which a total amount of a cash flow is displayed for each principal transaction). Each account of all-acquisition-costs-based balance sheet can offer the net gap as the difference between the beginning and the end of the period, and can generate income statement, cash flow statement (direct method) and statements of shareholders' equity or whatever itemized statement of accounts with aggregate amount that may be required in the future.

Further, through synchronization of material flow and monetary flow in terms of each item cord and lot number, statement of accounts with aggregate amount of each individual item becomes possible.

The Today's performance indicator calculation block can calculate the above-mentioned evaluation indicator SCCC according to the above-mentioned equation (2). Here, the evaluation indicator, “working capital circulation velocity, or supply chain cash conversion cycle (SCCC) implies the material flow of manufacturing lead time in one company, but also transaction processes carried out between multiple companies’ procurement of raw materials, product manufacturing, shipment, sales, and collecting. Accordingly, SCCC deals with the whole process of an item as one horizontal linkage. In order to accelerate the working capital circulation velocity SCCC, what is required is not only the shorter lead time of in-house production, but also the sooner terms of payment to the suppliers (parts suppliers, subcontractors etc.). To this end, visualizing the trend of indicator SCCC will serve accelerating the monetary flow of supply chain as a whole.

The Financial statements conversion block converts the above mentioned financial statements which are all entry price-based that maintains “the clean surplus principle” in which periodic profit of income statement equals to the incremental increase or decrease of the net asset in the balance sheet. Based on this all-acquisition-cost-based balance sheet, institutional financial statements of each country based on each financial accounting standard can be generated through translator system. Accordingly, all-acquisition-cost-based balance sheet with measured performance indicators can be used for measuring productivity in operation, and institutional financial statements based on each accounting standard is output for the external, institutional accounting use.

The balance sheet evaluation system according to the embodiment of the present invention evaluates the current status of creating flow and productivity, and is able to offer evaluation indicators that can judge the state of current management appropriately by means of the balance sheet.

Accordingly, swift shift of management thinking from “the more, the better with preference to the income statement” to “the faster, the better and preference to the balance sheet”.

The working capital circulation velocity evaluation system according to the embodiment of the present invention can offer an evaluation indicator used for measuring working capital circulation period of the supply chain as a whole from procurement of raw materials to product manufacturing, shipping, sales and collecting. Accordingly, through sooner terms of payment, cooperative relationship with outside suppliers is facilitated, thereby serving the macro-economy as well.

### BRIEF DESCRIPTION OF THE DRAWINGS

The present invention will be further described in detail below with reference to a plurality of referred drawings by giving a typical non-restricted example of an embodiment according to the present invention, but like numerals are denoted by like reference symbols in the drawings.

FIG. 1 is a table for explaining a tier structure of management information;

FIG. 2 is a diagram describing a concept of a process to be executed by a real-time balance sheet generating system;

FIG. 3 is a block diagram illustrating a configuration of a real-time balance sheet generating system;

FIG. 4 is a table describing examples of immediate journal entry in accordance with material flow;

FIG. 5 is table describing immediate journal entry, material flow in accordance with material flow, and updating a real time balance sheet and a today's balance sheet;

FIG. 6 is a diagram illustrating a method for calculating “balance sheet quality (BSQ)”;

FIG. 7 is a diagram illustrating a method for calculating a “supply chain cash conversion cycle (SCCC)”;

FIG. 8 is a diagram illustrating a method for calculating profit potential (PP);

FIG. 9 is a graph showing an example of a change in balance sheet quality (BSQ);

FIG. 10 is a graph showing an example of a change in supply chain cash conversion cycle (SCCC);

FIG. 11 is a graph showing an example of a change in fund raising lead time (CCC);

FIG. 12 is a table describing an example of a business analysis using balance sheet quality (BSQ);

FIG. 13 is a diagram illustrating a balance sheet;

FIG. 14 is a diagram describing that the balance sheet expresses a flow process from raising of capital to fund operation; and

FIG. 15 is a histogram showing an example of distribution of current profit of listed companies.

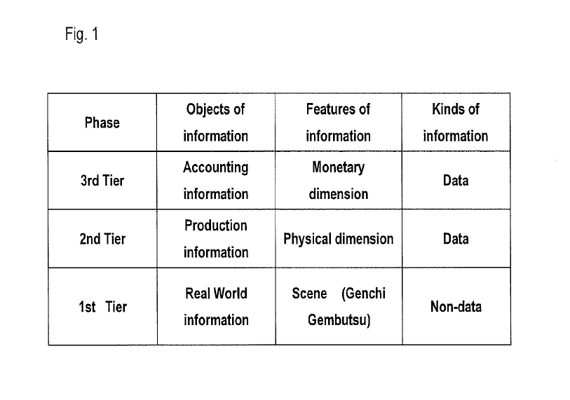

### DETAILED DESCRIPTION OF PREFERRED EMBODIMENTS

Hereafter, embodiments of the present invention will be described in detail with reference to the accompanying drawings.

Matters shown here are exemplary or describing embodiments of the present invention exemplarily, and the purpose of the description is to make conceptual features and principles of the present invention effective and easily understandable. In that sense, the explanation does not intend to provide structural details of the present invention above a level which is required for fundamental understanding, but to clarify programs and the apparatus for performing the method which materializes the embodiments of the present invention with description in conjunction with the drawings to a person skilled in the art.

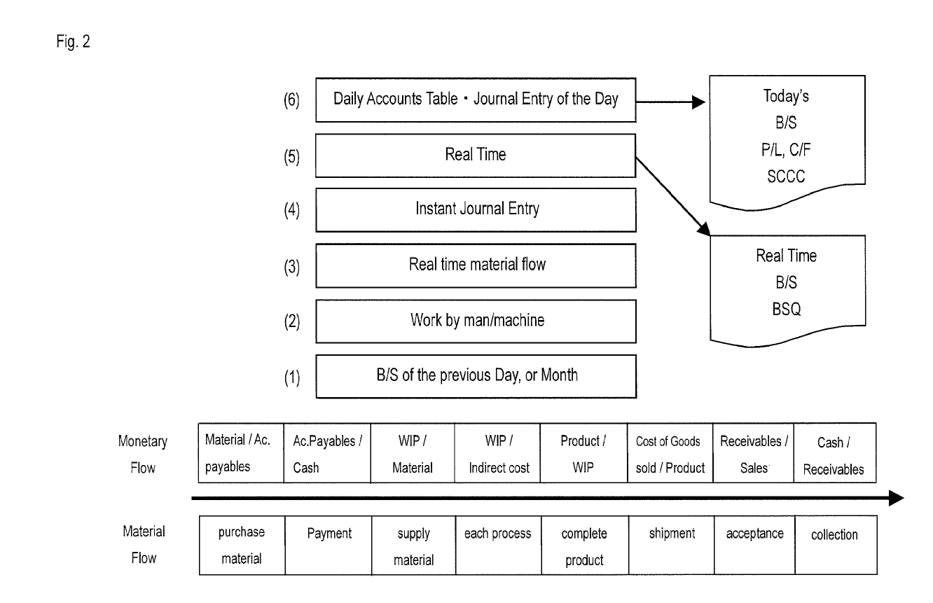

FIG. 2 is a diagram conceptually illustrating a real-time balance sheet generating system according to this embodiment of the present invention. In manufacturing industry, a material flow exists. The material flows include purchasing raw materials, purchasing price payment, supplying materials to factory, manufacturing processes, completion of product, shipment, delivery, acceptance and money collection. Correspondingly, a monetary flow is such that material/account payables (debit/credit: much the same is true on the following description), account payables/cash, work in process/material, indirect expense/work in process, finished goods/work in process, cost of goods sold/finished goods, account receivables/sales, and cash/accounts receivables. The real-time balance sheet generating system acquires real time material flow information that represents proceedings of processes (work by men or machines) and immediately journalizes the information, and by immediately updating a balance sheet of a previous day (or a month), immediately generates the updated balance sheet (a real-time balance sheet). This updated real time balance sheet can instantly provide an indicator BSQ (balance sheet quality) for evaluating the degree of evolution in “creating flow”. Further, the real-time balance sheet generating system, by acquiring and journalizing the above mentioned “today's material transaction data” and “today's monetary transaction data”, journalizes those transactions and generates “today's trial balance”, and based on this today's trial balance, updates the previous balance sheet, and generates financial reports of the day (balance sheet, income statement, and cash flow statement). According to these today's financial reports, performance indicator supply chain cash conversion cycle (SCCC) for evaluating the working capital circulation velocity of the day can be calculated.

### 1. Configuration of the Real Time Processing

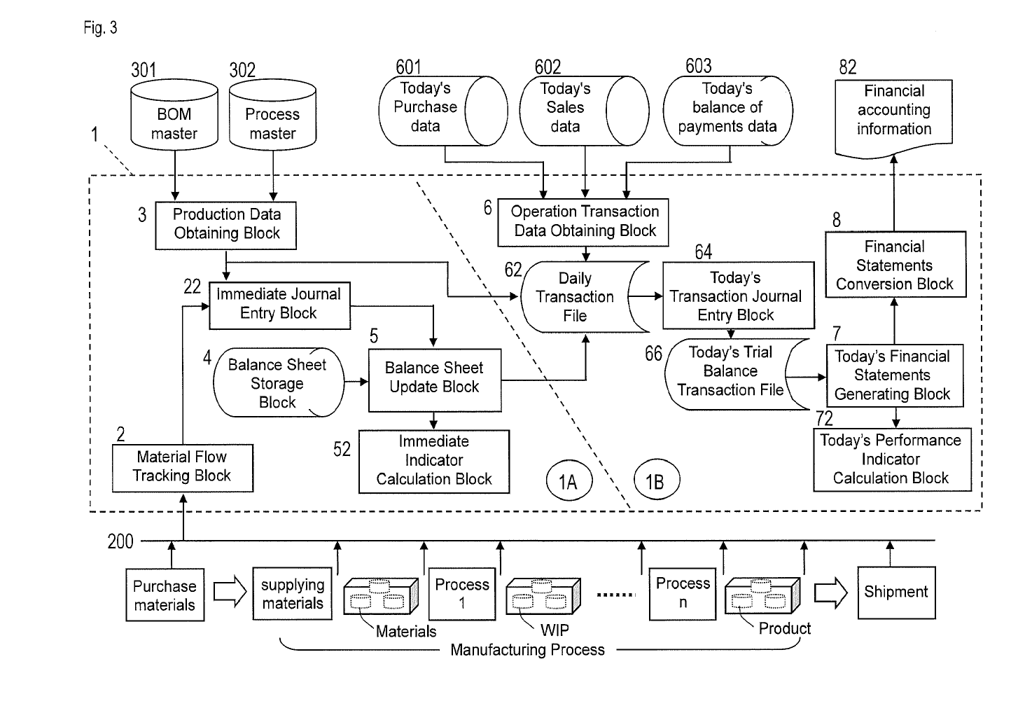

FIG. 3 illustrates configurations of a real-time balance sheet generating system 1 and of a real-time balance sheet generating program according to this embodiment. An immediate processing area lA illustrated in FIG. 3 mainly expresses the configuration that executes a process for updating a real-time balance sheet in response to ever-changing material flows.

The real-time balance sheet generating system 1 includes a material flow tracking block 2, a production data obtaining block 3, a balance sheet storage block 4, an immediate journal entry block 22, and a balance sheet update block 5. The material flow tracking block 2 acquires material flow information in real time in terms of an item and a lot number at each process ranging from purchasing raw materials to production shipment. The production data obtaining block 3 accesses master files (301 and 302) in a production control system separately provided to acquire production data that includes data about bill of materials (BOM) and process data. The balance sheet storage block 4 stores a balance sheet on a previous day. The immediate journal entry block 22 refers to the production data acquired by the production data obtaining block 3 so as to instantly and sequentially journalize inventory assets related accounts of the balance sheet, based on the material flow information obtained by the material flow tracking block 2. The balance sheet update block 5 immediately and sequentially updates the balance sheet stored in the balance sheet storage block 4 in accordance with a result journalized by the immediate journal entry block 22, and generates the balance sheet at the latest moment as a real-time balance sheet.

The real-time balance sheet generating system 1 includes an immediate indicator calculation block 52 that is able to immediately calculate the evaluation indicator, BSQ of the day.

### (Material Flow Tracking Block)

The material flow tracking block 2 is configured so as to acquire material flow information at each process including purchasing raw materials through completion and shipment of product in real time in terms of an item code and a lot number of each product. Material flow information can be acquired in sequence at each process, as shown in FIG. 3, for example, at purchasing raw materials, releasing materials to a manufacturing process, passage through an inlet and an outlet of each process, completion of product, shipment of product etc. Material flow information acquired at every moment in the material flow tracking block 2 is immediately sent to the immediate journal entry block 22.

In FIG. 3, the material flow tracking block 2 is configured so as to acquire material flow information through a network 200. However, as long as the required flow information, such as a passing time at each process, an item number, a lot number, quantity etc., can be acquired at the time of occurrence of a material flow, specific configurations of means are not limited. A separately provided material flow tracking system may be configured, or the real-time tracking system may be configured as a part of the real-time balance sheet generating system 1.

Means for obtaining the above mentioned material flow information is particularly no object. For instance, a device and network that is generally called Internet of Things (IoT) can be employed. Further, an IP address may be provided to work or to a sensor that detects material flow. Means for attaching information to work is no object. Examples of such means include a device having an IP address, an RFID tag, and a two-dimensional code etc., and these codes can be attached to parts, products, or to returnable boxes or packing boxes.

### (Production Data Obtaining Block)

Configurations of the production control system used in a manufacturing industry are various so that the configurations are not particularly limited. However, production control system generally includes a bill of materials master file in which material data is stored, a process master file in which process data is stored, a costing master file in which cost data is stored, etc. For instance, the bill of materials master file, which is generally called BOM, contains item numbers, components parts of products, names of parts, model, a name of a manufacturer, a unit price, required quantity, and other base data. Further, the process master file generally contains a number of manufacturing lots of each item, an operation procedure of a manufacturing process, used equipment, standard working hours, base data for overhead costing, etc.

The production data obtaining block 3 is configured so as to access a master file (for example, a bill of materials master file 301, a process master file 302, etc.) generally provided to a production control system and obtain production data including BOM data and process data. In the production control system connected to the real-time balance sheet generating system 1, configurations of the bill of materials master file 301 and the process master file 302 are no object. The real-time balance sheet generating system 1 refers to the production data obtained by the production data obtaining block 3, and thus can track material flow information obtained by material flow tracking block 2 in terms of each item and each lot number.

It is preferable that the bill of material master file, the process master file, etc. provided in the production control system be appropriately updated in accordance with real-time material flow information about raw materials through completion of product via intermediate process.

### (Immediate Journal Entry Block)

The immediate journal entry block 22 is configured so as to refer to the above mentioned production data obtained by the production data obtaining block 3 and instantly and sequentially journalize accounts related to inventory assets in a balance sheet (materials, work in process, product, etc.), based on every material flow information obtained until the last minute by the material flow tracking block 2. Every piece of material flow information obtained until the last minute is whole material flow information generated until the present after a balance sheet to be a reference is created. For example, when a balance sheet to be a reference is a balance sheet on the previous day, every piece of material flow information obtained until the last minute is whole material flow information generated at each moment from a starting time of the day to the present. Therefore, whole material flow information generated after a balance sheet to be a reference is created is reflected in a journalized result. Time length for output can be set to be any value.

This journal entry process is configured to be immediately and sequentially (in the order of occurrence) executed at each moment when material flow information is obtained by the material flow tracking block 2 (each piece of information including purchasing raw materials, supplying materials to a factory, passage through an inlet and an outlet of each process, completion of product, shipment). By referring to the production data (item and lot number) obtained by the production data obtaining block 3, and the journal can be automatically processed in terms of each item and each lot number.

In addition, since each passing moment of process for raw materials, work in process, finished product, and shipment can be grasped in real time, any abnormality of material flow can also be instantly detected in real time by the immediate journal entry block 22.

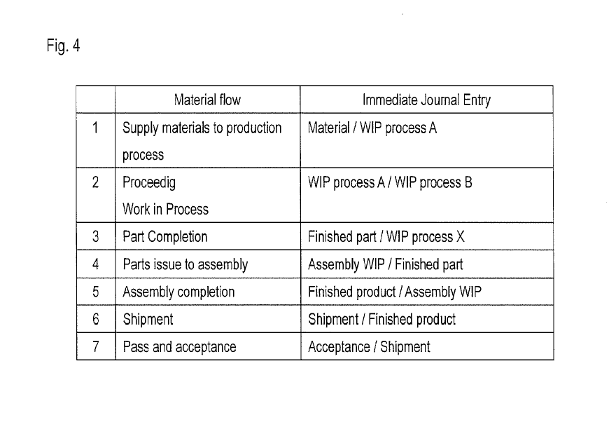

FIG. 4 shows an example of a journal entry process performed by the immediate journal entry block 22. The left column of the table shows material flow information, and the right column shows journal entry caused by that material flow information.

For example, upon receiving information that a raw material has been supplied to the first process, the immediate journal entry block 22 refers to BOM data and journalizes the amount of value as “raw material XX/work in process XX” (debit/credit). Further, when receiving one piece of information of a “job progress in a manufacturing process, the immediate journal entry block 22 refers to the process data and journalizes the calculated cost as “WIP process A XX/WIP process B XX”. Likewise, the immediate journal entry block 22, on receiving material flow information, instantly does journal entry sequentially following the order of occurrence.

### (Balance Sheet Storage Block)

The balance sheet storage block 4 is configured so as to store the most recent balance sheet which becomes a reference for updating a balance sheet in real time. The balance sheet as a reference is not particularly limited. A balance sheet of the previous day, or a balance sheet of the beginning of a month, or a balance sheet of a previous fiscal end can be the reference balance sheet. Alternatively, multiple balance sheets as the reference balance sheet can also be stored as the reference balance sheet and can be appropriately selected to be used.

### (Balance Sheet Update Block)

The balance sheet update block 5 is configured so as to, by using the result of journal entry performed by the immediate journal entry block 22, immediately and sequentially update the balance sheet stored in the balance sheet storage block 4, and generate the balance sheet at the latest moment (at the present) as a “real-time balance sheet”.

As mentioned above, the material flow tracking block 2 obtains material flow information (process passage information) at each stage of raw materials, work in process, a finished product and shipment, and accordingly the immediate journal entry block 22 executes journal entry immediately. Accordingly, the balance sheet update block 5 reading the reference balance sheet stored in the balance sheet storage block 4, and updates the balance sheet so as to reflect the result of the journal entry in the reference balance sheet. Thus, a latest moment balance sheet is generated as a real time balance sheet.

Further, as the journal entry is done in terms of item and lot number by the immediate journal entry block 22, the balance sheet update block 5 is able to generate a real time balance sheet in which a change in inventory assets in terms of item and lot number is reflected. Accounts that can be updated in the real time balance sheet are limited to a range where the material flow exerts its influence. A change due to a monetary flow is reflected in a today's balance sheet described later.

### (Immediate Indicator Calculation Block)

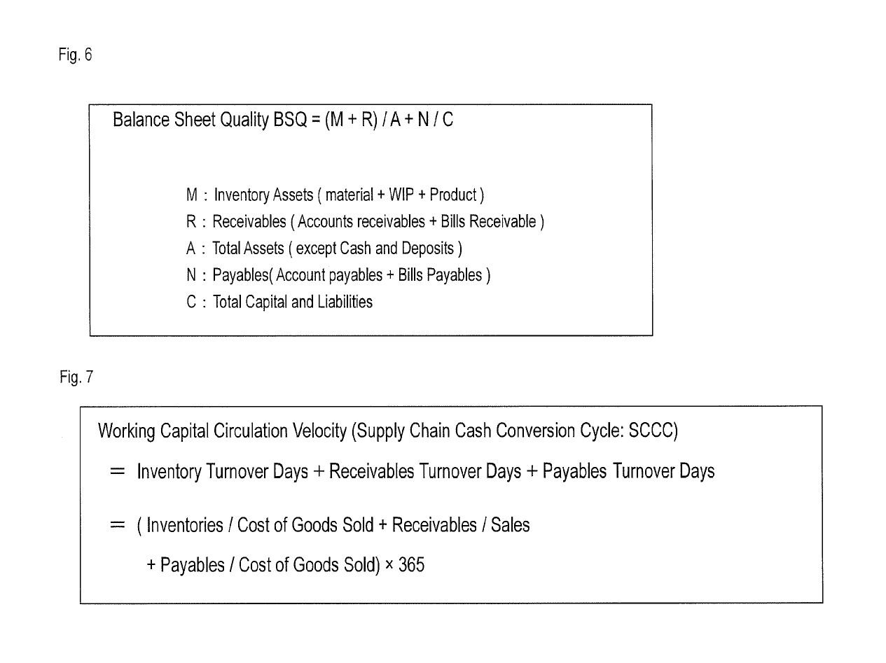

The real-time balance sheet generating system 1 includes an immediate indicator calculation block 52 that can immediately calculate the evaluation indicator the balance sheet quality (BSQ) shown in FIG. 6 (the following equation (1)).

BSQ=(M+R)/A+N/C (1)

In the equation, M represents the amount of inventory assets (the sum of raw material, work in process, and finished product), R represents the amount of notes and accounts receivable (the sum of accounts payable and acceptance receivable), A represents the amount of total assets excluding cash, N represents the amount of accounts payables (the sum of account receivables and acceptance payables), and C represents the amount of total Liabilities and shareholder's equity.

The BSQ value can be updated in real time based on a real-time balance sheet. The real-time balance sheet generating system 1 is able to update the BSQ value in response to an ever-changing material flow. Thus, the BSQ makes it to measure the degree of evolution in “creating flow”.

According to the configuration described above, the real-time balance sheet generating system 1 is able to update a balance sheet and a BSQ value in real time, and visualize them. Further, the real-time balance sheet generating system 1 is able to detect variance and anomaly in the inventory assets, and other abnormal material flows. As a result, the real-time balance sheet generating system 1 does not need quantity confirmation work for checking actual things at the fiscal closing. Further, automatic and constant matching of BOM and work schedule can be automatically performed, and thus quantity variance confirmation that is the major event at the fiscal closing almost diminishes.

### 2. The Configuration of the Daily Processing

According to the configuration illustrated in a daily Processing area 1B, the real-time balance sheet generating system 1 is able to generate major three financial reports of the day (balance sheet, income statement, and cash flow statement) by combining a material flow and a monetary flow.

For this reason, the balance sheet update block 5 is configured so as to journalize the amount of increase or decrease in inventory assets in a today's balance sheet against the amount of inventory assets in a previous day's balance sheet, and store a journalized result as today's material transaction data in the daily transaction file 62. The real-time balance sheet generating system 1 includes an operation transaction data obtaining block 6, a today's transaction journal entry block 64, and a today's financial statements generating block 7. The operation transaction data obtaining block 6 obtains today's purchase transaction data 601 which includes the occurrence and payment of accounts payable, today's sales transaction data 602 which includes occurrence of accounts receivables and the collection of the price as well as today's balance of payments data 603 which includes today's deposit and withdrawal. The operation transaction data obtaining block 6, then, makes journal entry for each account of the today's purchase transaction data 601, today's sales transaction data 602, and today's balance of payments data 603, and stores journalized results as today's operating transaction data in the daily transaction file 62. The today's transaction journal entry block 64 journalizes the data in the above mentioned today's material transaction data and the today's operating transaction data stored in the daily transaction file 62, and stores the results in a today's trial balance transaction file 66. The today's financial statements generating block 7 generates a balance sheet, income statement and the cash flow statement of the day, as major three accounts of the day, based on the journalized result stored in the today's trial balance transaction file 66.

In addition, delimiting of the day length on the time axis may be set to be any value.

Further, the real-time balance sheet generating system 1 also includes a today's performance indicator calculation block 72 that evaluates a performance indicator SCCC expressed by the above mentioned equation (2), based on the major three financial reports.

Further, the real-time balance sheet generating system 1 includes a financial statement conversion block 8 that converts the above mentioned today's three major financial reports to generate three major financial reports based on predetermined individual accounting standards.

The balance sheet update block 5 is configured so as to journalize incremental increase or decrease in inventory assets in a real-time balance sheet of the day against the inventory assets in the balance sheet of the previous day, and stores the journalized result as in the daily transaction file 62 as the material flow transaction of the day. As a result, the result of journal entry in which a material flow of the day is reflected is stored in the daily transaction file 62 as the material flow transaction of the day. Thus, the balance sheet of the day mentioned above finally becomes the updated real time balance Sheet of the day.

(Operation Transaction data obtaining block)

The operation transaction data obtaining block 6 is configured to acquire today's purchase transaction data 601, today's sales transaction data 602, and today's balance of payment data 603, to make journal entry of each account, and to store the result in the daily transaction file 62 as operation transaction data of the day. In this configuration, data acquisition method in each of the today's purchase transaction data 601, the today's sales transaction data 602, and the today's balance of payments data 603 is not limited. For instance, linking with existing purchase, sales or finance system and acquiring data from those existing system is also possible. That is, the operation transaction data obtaining block 6 is configured to be able to acquire data by accessing the existing system. Further, journal entry in the today's purchase transaction data 601, the today's sales transaction data 602, and the operation transaction data obtaining block 6 can be made in terms of each individual item number by referring to production data acquired by the production data obtaining block 3.

In addition, transaction data relating to the above mentioned purchase, sales, and finance systems had better be immediately and accurately processed by means of automatic business form data input etc.

As a result, in the daily transaction file 62, data of the day regarding the result of journal entries of as the material flow transaction data, the increase or decrease of inventory assets caused by the day's material flow of the day and the monetary flow of the day corresponding to material flow are gathered. Further, in the daily transaction file 62, results of journal entries as the operation transaction data regarding today's purchase transaction data 601, the today's sales transaction data 602, and the today's balance of payments data 603 are gathered.

### (Today's Transaction Journal Entry Block)

The today's transaction journal entry block 64 journalizes the above mentioned material flow transaction data and operation transaction data stored in the daily transaction file 62, and generates today's transaction journal entry (daily account table together with and journal entry of the day' is called here transaction journal entry). Then, the today's transaction journal entry block 64 is configured so as to let the journal entry of the day in a today's trial balance transaction file 66.

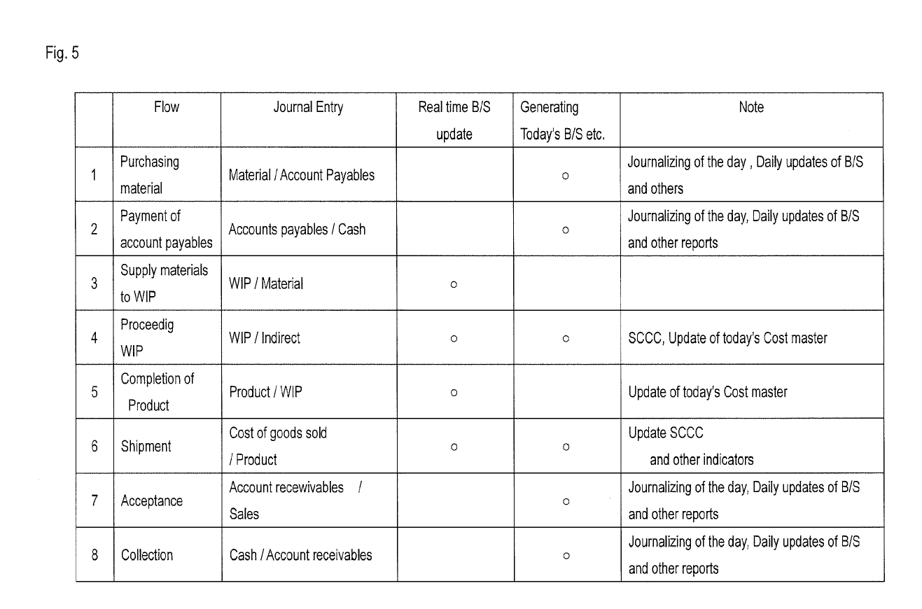

FIG. 5 is a table for explaining the process of journal entry following the material and monetary flow of the day, and update of the real time balance sheet and the today's balance sheet.

For instance, when the material flow information is tracked at ‘raw material input’, ‘process proceeding’, ‘completion’, ‘shipment of product’ etc., journal entry is immediately made. Then, the balance sheet update block 5 updates the real time balance sheet. Then, journal entry of the amount of increase or decrease in the balance sheet account against that of the previous day is sent to the daily Transaction File 62″ as the material transaction data of the day.

On the other hand, in the monetary flow of the day, for instance, when a data of ‘purchased raw material’ is obtained from the purchasing system, the transaction value is journalized as “material/account payables” (debit/credit). Further, when a data of ‘account payable was paid’ is obtained, the transaction value is journalized as “account payable/cash”. Likewise, the today's transaction journal entry block 64 journalizes other data of monetary flow of the day and stores them in the daily transaction file 62.

Then, the today's transaction journal entry block 64 matches material and monetary transaction data gathered in the daily transaction file 62, journalizes all the transactions of the day, and generates the trial balance of the day to store them in the today's trial balance transaction file 66.

In the daily transaction file 62, journalized data of each individual activity in the process of purchasing, payment, supplying raw material, work in process, completion of product, shipment, acceptance and bill collecting are stored, the sum of which enables to detect the mistake or abnormality of amount or timing in receiving and making payments or other transactions.

### (Today's Financial Statements Generating Block)

A today's financial statements generating block 7 is configured so as to generate the balance sheet, the income statement, and the cash flow statement based on the journal entries stored in a today's trial balance transaction file 66.

As illustrated in FIG. 5, a today's balance sheet is updated every day about each purchase of raw material, accrual of account payable, process proceeding, shipment, delivery, money collection etc. that happened on the same day.

An important thing in a today's balance sheet of block 7 of FIG. 3 is that all the assets and liabilities are evaluated by acquisition cost, not by current price, which enables managers of the company to know the real profitability of their operation, being unaffected by external, environmental conditions.

In rendering an institutional financial report, any acquisition cost based accounts in today's balance sheet (FIG. 3 block 7) can be translated into any institutional reports by manual journal revision entry and automatic translation system that can convert them into any institutional reports.

Further, today's financial statements generating block can generate income statement (income statement of the day), and cash flow statement the day) through operating activities of the day. This income and cash flow combined statement can prove the evolution in creating flow of Gemba.

At job termination of the day, when there is journal entry of balance sheet related accounts except for current assets and current liabilities, journal entry is made by manual input to generate today's balance sheet. All the accounts of today's balance sheet are recorded by acquisition cost (entry price), so that the net profit of the day is measured as the difference of net asset of the day and the previous day.

Value added (=sales−material cost) of the day can be known from the income statement of the day, and cash flows from operating activities of the day can be known from the cash flow statement of the day. Thereby, in the manufacturing site (Gemba), daily plan-do-check-act (PDCA) that can connect today's reflection on tomorrow's improvement activities can be formed.

An important thing of accounting theory is that fact that the head of the financial reports is the balance sheet in which the income statement and the cash flow statement are annexed detailed statements of the balance sheet. The real time balance sheet configured by this invention can dissolve the dichotomic idea that “the income statement is flow information, while the balance sheet is stock information, and aiming for the improvement of the balance sheet quality on mid and long term basis will be supported.

### (Today's Performance Indicator Calculation Block)

The real time balance sheet system 1 is equipped with the today's performance indicator calculation block 72 that can calculate the performance indicator SCCC according to the major three financial statements of the day in which accounts in the financial statements are all acquisition cost (entry price) based. The indicator SCCC is expressed by the following equation.

SCCC=(M/Cₛ+R/S +P/Cₛ)·D (2)

In the equation, M is inventory assets, Cₛ is cost of goods sold, R is accounts receivables, S is sales, P is accounts payables, and D is the annual number of days (365).

The SCCC value can be updated daily. In addition, as long as the data in the today's purchase transaction data 601, the today's sales transaction data 602, and the today's balance of payments data 603 are combined and be obtained in real time, the SCCC value can also be immediately calculated.

As shown in FIG. 7, SCCC is the sum of inventory turnover days, accounts receivable turnover days and accounts payable turnover days. As an indicator to measure a required fund procurement period, cash conversion cycle (CCC) is known. SCCC differs from the conventional CCC in that account payables are added instead of being subtracted in SCCC. In both SCCC and CCC, total value is the smaller, the better, but its implication greatly differs.

The CCC value gets smaller by extending the term of payment to the sub-supplier without making any efforts for the shorter lead time inside. In that case, material flow in society as a whole rather aggravates. On the contrary, a parent enterprise's SCCC value gets smaller by adopting the shorter term of payment to the subcontractor, which implies money circulation velocity gets faster both for the supply chain and for macro economy as well.

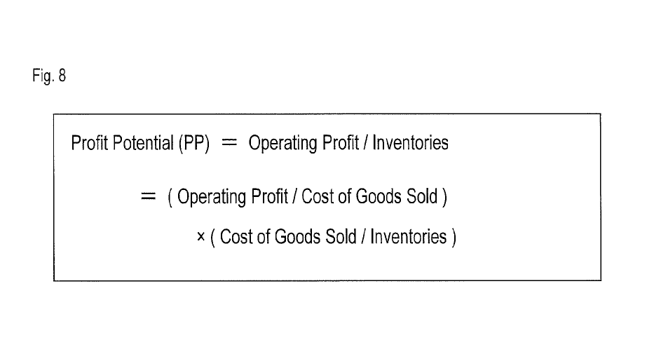

The today's performance indicator calculation block 72 can calculate the performance indicator as expressed in the following equation (3) based on the above mentioned three major financial reports which is recorded on all acquisition cost basis (refer to FIG. 8).

PP−operating profit/inventory assets (3)

Management that looks at only profit in the income statement tends to allow large batch size or the earlier than necessary starts of production that aggravates the material flow and cash flows. These trends can be checked by the performance indicator profit potential (PP). Although the indicator PP is a known indicator to evaluate the quality of operating profit relative to the incremental increase or decrease of inventories, the real-time balance sheet generating system 1 is able to evaluate the degree of “creating flow” every day in terms of this profit potential.

The daily transaction file 62 that has completed the above-described process becomes input data for the daily update of the master file of the existing “sales”, “procurement”, “production control” and “financial accounting” systems. Further, the BOM master file and the process master file regarding the material flow are able to undergo real-time update.

### (Financial Statements Conversion Block)

The real-time balance sheet generating system 1 is equipped with the financial statements conversion block 8 which generates major three financial reports based on any prescribed financial accounting standards by translating the above described financial statements into those based on each prescribed international financial reporting standard (IFRS). As the above-described major three financial reports are all recorded by the acquisition costs (input price basis). The financial Statements conversion block 8 converts the above described financial statements into those based on each independent prescribed institutional financial accounting standard (output price basis). Specifically, the financial accounting information 82 can generate financial reports that reflects financial standard for closing journal entry for domestic standard that reflects fare price, US standard, IFR Standard, and so forth.

Specific configuration of “Financial Statements Conversion Block 8” does not particularly matter. For instance, by preparing the translator (dictionary for conversion) for each individual standard, for instance, inventory assets evaluated by net realizable value, proceeds from foreign currency, purchase or sales items that reflect exchange rate fluctuations and so forth, the financial statements conversion block 8 can generate the balance sheet and other financial reports of each independent prescribed standard.

The above mentioned “balance sheet update block 5” is configured so as to automatically journalize incremental increase or decrease of inventory assets of the day against the inventory assets in the balance sheet of the previous day, the result of which is to be stored in “daily transaction file 62” as the material flow transaction of the day.

Today's balance sheet and other financial reports based on all acquisition costs generated by the today's financial statements generating block 7, performance indicators calculated by the today's performance indicator calculation block 72, and performance indicators calculated by the immediate indicator calculation block 52 are stored in the real-time balance sheet generating system 1, and can be used for internal management purpose.

Further, the real-time balance sheet generating system 1 can maintain data such as real time balance sheets, performance indicator BSQ, major three financial reports, performance indicator SCCC and so forth, and is able to output temporal variation of those data, and visualize them with appropriate terms.

### 3. Balance Sheet Evaluation System and Working Capital Circulation Velocity Evaluation System

### (Balance Sheet Evaluation System)

A balance Sheet evaluation program is, based on the introduced balance sheet, configured so as to calculate the performance indicator BSQ in FIG. 6 according to the following equation (1).

BSQ=(M+R)/A+N/C (1)

In the equation, M is the amount of inventory assets (sum of raw material, work in process and finished product), R is the amount of notes and account receivable, A is the amount of total assets excluding cash, N is the amount of account payables, and C is the amount of Total Liabilities and shareholder's equity).

The performance indicator balance sheet quality (BSQ) is the indicator to evaluate the degree of evolution in “creating flow”. A balance sheet evaluation system can introduce the balance sheet data generated at any time, and can calculate the evaluation indicator BSQ based on the balance sheet data by means of any compute through which it becomes possible to calculate BSQ at any period in the past or the present and thus to visualize the degree of evolution in “creating flow”. The method of introducing the balance sheet dose not particularly matter. The balance sheet data stored in computer may be retrieved, or the balance sheet data may be input from external system. In addition, the balance sheet does not require to be limited to all acquisition cost based one. Depending on the purpose, BSQ conforming to any prescribed standard can also be calculated.

### (Working Capital Circulation Velocity Evaluation System)

A working capital circulation velocity evaluation system is configured, based on introduced balance sheet and income statement, so as to calculate the performance indicator SCCC according to FIG. 7 (following equation (2)).

SCCC=(M/Cₛ+R/S+P/Cₛ)*D (2)

In the equation, M is inventory assets, Cₛ is cost of goods sold, R is accounts receivables, S is sales, P is accounts payables, and D is the annual number of days (365)).

The performance indicator supply chain cash conversion cycle (SCCC) evaluates working capital circulation velocity in the supply chain ranging from procurement of raw material, manufacturing product, shipment, sales to collection of bills. A working capital circulation velocity evaluation system can use the balance sheet and the income statement generated at any time, and can calculate the performance indicator SCCC by means of any computer, thereby visualizing the change of working capital circulation velocity at any time period in the past or the present. By using the performance indicator SCCC, the sooner payment to the supplier will promote collaboration between the parent company and sub-contractors as well as the faster money circulation in macro economy. As mentioned above, the balance sheet and the income statement do not require to be limited to all acquisition cost based one. Depending on the purpose, SCCC can also be calculated based on the balance sheet and the income statement conforming to any prescribed standard.

### 4. The Effect of Real-Time Balance Sheet Generating System

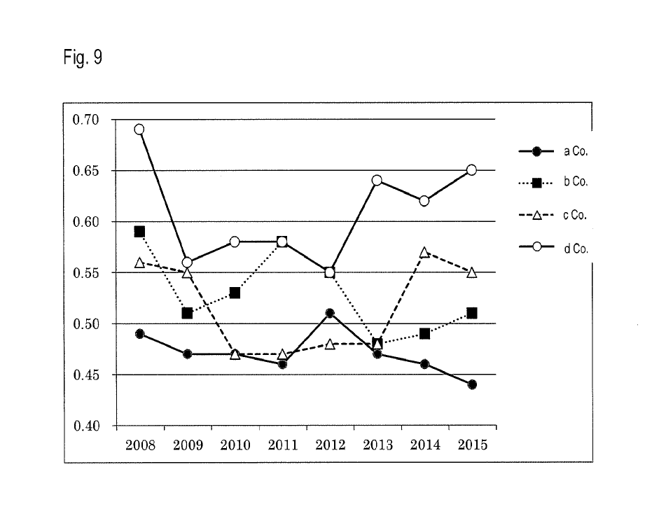

FIG. 9 to FIG. 11 express the change in performance indicators for creating flow, that is, BSQ, SCCC, and the conventional CCC, of four manufacturing Companies (a, b, c, d) that belongs to the same type of industry.

FIG. 9 is a line graph that expresses the balance sheet quality (BSQ) values of the four companies. By promoting “creating flow”, inventories decrease so that the ratio of inventories relative to the total assets decreases, and due to the shorter lead time, the occurrence of trade payables gets slower, resulting in an increase in cash on hand, thereby making the BSQ value small. Therefore, BSQ becomes an indicator to be able to measure the evolution of creating flow as well as the improvement of profitability. FIG. 9 tells that relatively smaller BSQ value proves that ‘company a’ is the best promoting “creating flow”.

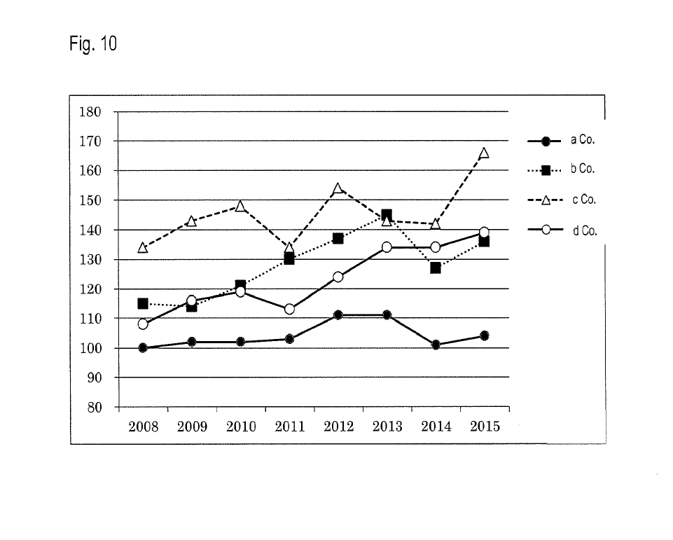

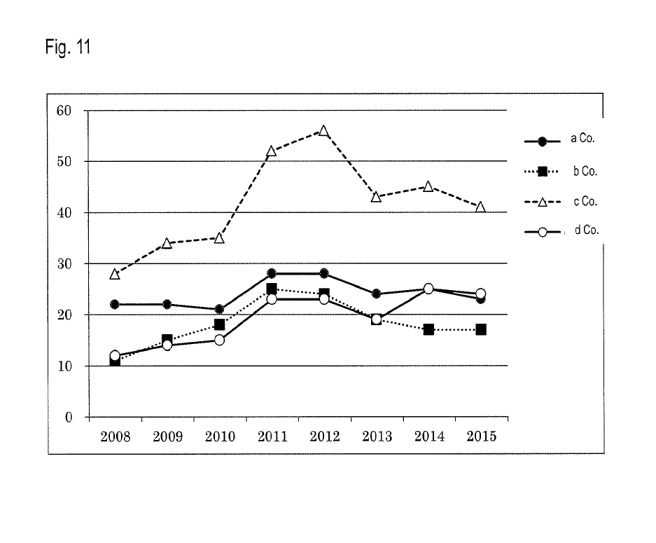

FIG. 10 and FIG. 11 are line graphs of the same four companies, which express respectively the change of SCCC and the conventional CCC. Comparison of both graphs, focusing on the situation of ‘Company b’, in terms of CCC in which accounts payable turnover days are subtracted, the position of ‘Company b’ looks relatively good. However, in terms of SCCC in which accounts payable turnover days are added, the position of ‘Company b’ looks worse. Accordingly, comparison of these two graphs exposes the slower internal material flow and the longer payment period of ‘Company b’ relatively to ‘Company a’. Whereas SCCC value of ‘Company a’ tells the relatively shorter inventory assets turnover days as well as the shorter payment period than those of ‘Company b’. Up to now, companies tended to think “the longer the better, the period is”. However, for the smarter business, dispelling this conventional thinking and accelerating working capital circulation velocity in the supply chain as a whole is important.

In addition, the conventional notion of CCC value still need not discarded as it still valid in measuring the “required working capital procurement period”. However, in order to calculate CCC, replacing “adding” accounts payable turnover days with “subtracting” is enough, and this means that the notion of CCC is not substantially unnecessary.

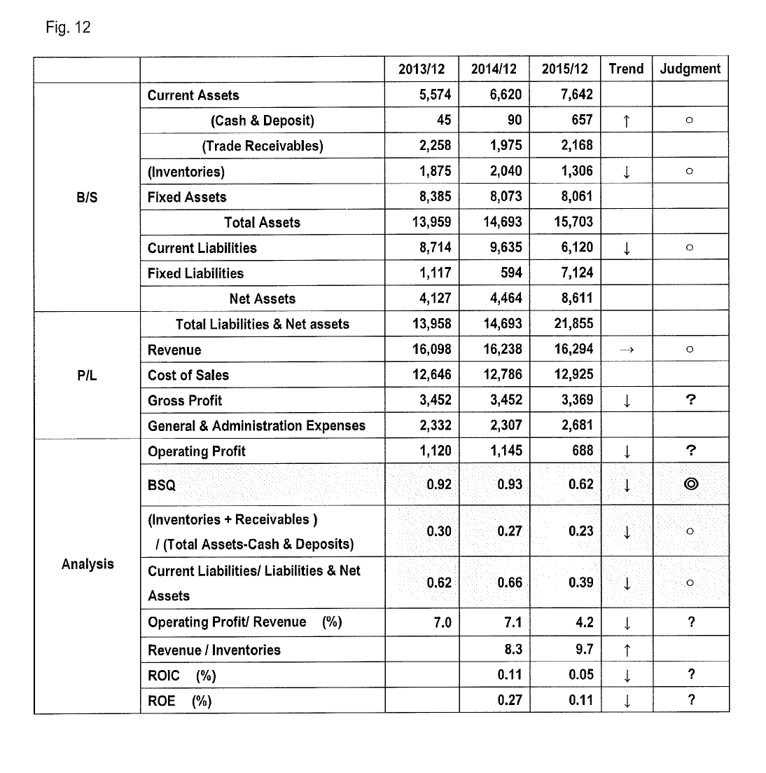

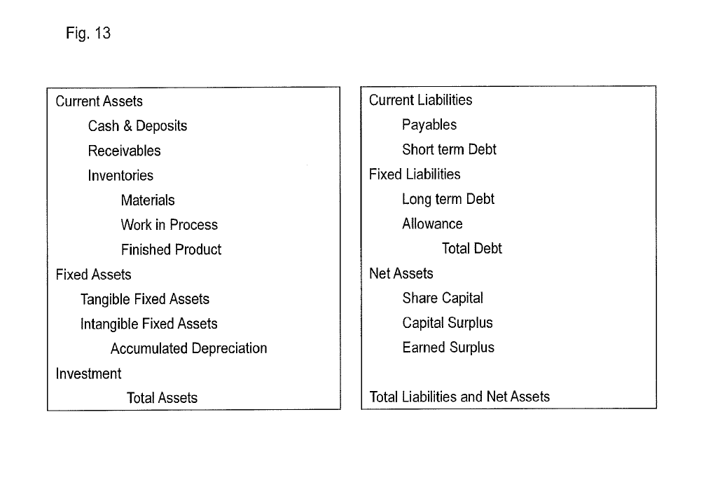

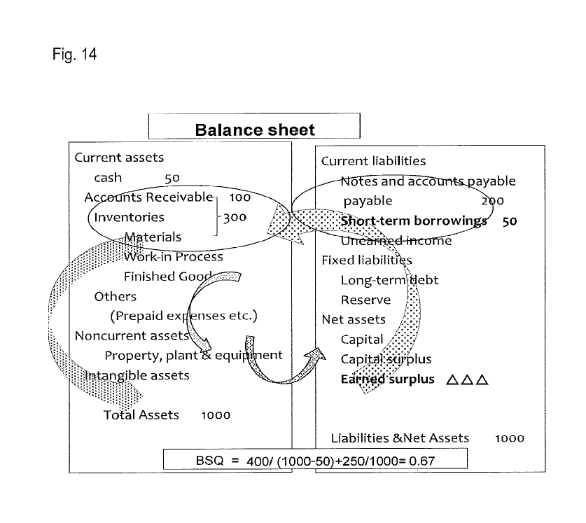

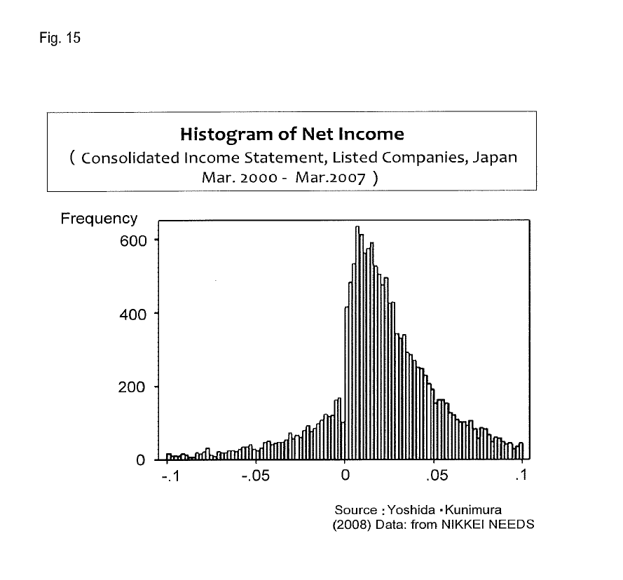

FIG. 12 expresses the example of a ‘Company X’ measured by the balance sheet, income statement and the evaluation performance calculated by the real-time balance sheet generating system 1. The Company X started “creating flow” activities in 2015, and FIG. 12 shows the comparison of performance of the starting year with that of previous year.

In this example, in the first year when creating flow started, although sales amount was roughly the same, inventories dramatically decreased, while cash flow (liquidity on hand) radically increased, which was very good news. However, along with these good news, bad news also happened as radical fall of operating profit, deteriorated operating profit on sales as well as greatly decreased return on equity (=net profit/owned capital, ROE). A serious problem here is that for those who have excessive interest in the short-term profit, it is very difficult to judge exactly such commixture of good and bad news, and, what is worse, the kind of contradiction becomes all the more serious as the degree of success of creating flow gets all greater. For this reason, not a few companies stop promoting creating flow projects.

According to the indicator BSQ, the effect of the shorter production lead time can be measured accurately by means of accounting. In the case above, BSQ's fall from 0.93 to 0.62 tells that radical fall of the popular index ROE of ‘Company x’ is rather good news caused by profit decrease under the state of improved BSQ value. This proves the productivity and profitability of ‘Company x’ getting stronger. Thus, the effect of evaluation by BSQ is to correct excessive interest in the short-term profit of enterprise or society, and to improve the capability of judging the profitability of companies in financial institutions and capital market.

In this way, the effect of creating flow can be directly visualized in the balance sheet and the cash flow statement, but not in the income statement for the moment so that the effect of creating flow tends to be misunderstood. The essence of the management for the faster flow is to make material and money flow smoothly, without stagnation, or to make the total supply chain ranging from “purchasing raw material”, internal production processes, shipment, acceptance to the bill collection flow without a break. The real-time balance sheet generating system 1 outputs and visualizes KPI that supports creating flow on monitor display, thereby enabling the values of manufacturing to shift from “resource operation focused productivity that emphasizes short-term profit in income statement” to “material flow focused productivity that emphasizes mid- or long-term profit that emerges in the balance sheet. The real-time balance sheet generating system 1 can collect these KPIs. Management of ‘Company x’ thus can advance to the second year of creating flow project with delight with the conviction in mind that “creating flow” is “the balance sheet focused, for the better BSQ” management.

The real-time balance sheet generating system 1 is able to generate “income/cash flow combined statement” which integrates the existing two financial reports (income statement and cash flow statement that are obliged to submit for listed companies) with a summarized form in one table, and visualize it onto the display device for managers, thus enabling them to recognize at a glance that the profit decrease caused by the fewer inventories is simply ‘cash flow increase’. Accordingly, it is expected that the trends in which to pay attention overly to the bottom-line profit in income statement, while belittling the importance of cash flow be corrected by this combined exposure of operating profit in income statement and cash flow from operating activities (indirect method) in one table, thereby continuously measure and visualize the evolution of BSQ and SCCC value through the update of financial data (material accounts in real time, and monetary accounts every day).

Methods like this enables the company as a whole concentrate its energy on the “creating flow” project. In addition, with regard to ROE which is emphasized in the capital market, BSQ value can be used for checking the possibility of lawful but cosmetic accounting like increasing inventory or increasing liabilities (heighten leverages), thus creating unrecognizable profits, while damaging the quality of the balance sheet. Thus, the KPI of BSQ enables evaluation of the degree of creating flow efforts as well assurance the credibility of ROE itself.

As the real-time balance sheet generating system 1 can grasp the material flow in terms of item and lot number, difference between the planned and actual quantity is automatically grasped in the BOM and process master file, stocktaking work for settlement becomes unnecessary as long as quantity difference is concerned.

Further, when the “pull” method in so-called just in time production makes progress, parts required for assembly arrives at the side of assembly line before starting production. When the production of the day finishes, payment of purchase money of the part can be automatically processed by matching with BOM, thereby, manual matching of order form, invoice and bill diminish, and monthly end concentration accounts payable operations is levelled.

Further, evaluation by the indicators of BSQ and SCCC based on balance sheet has a wide social and economic effect, including capital market and financial institutions.

By regarding the better BSQ value as a prerequisite of ROE, accounting fraud by enterprises decreases. Capital market or financial institutions can reduce misjudgment on the profitability of enterprises by relying less on income statement related indicator like profit ratio of sales. Enterprises themselves as well can reduce the risk of emphasizing short-term profit, and can head for “creating flow”, by regarding BSQ as important. In addition, improving SCCC increases the financial power of small and medium sized enterprises.

The real-time balance sheet generating system influences accounting theory as well. Hitherto prevalent “period profit and loss calculation” under the “revenue and expense view”, the role of the balance sheet was a supporting role called “storage box of items still unsettled in profit and loss calculation”. However, the time has come in which translating the material flow into the real time balance sheet, thus reviving again the old “asset and liability View”.

What made such revival of balance sheet focused accounting view feasible is the above described “all acquisition costs based balance sheet” in which the “clean surplus principle” is viable, in which the difference in net assets of the balance sheet between the beginning and the end of the term is equal to net profit in income statement. Such “all acquisition costs based balance sheet” can be generated only by the information technology called IoT that is able to grasp the material flow in real time.

In addition, in the present invention, the embodiments are not limited to those described above. Variously altered embodiments within the scope of the present invention can be employed in accordance with specific purpose or use.

1. A real-time balance sheet generating system comprising:
a material flow tracking block configured for obtaining material flow information about each lot of an item in real time throughout a process from purchasing raw materials to shipping the product;
a production data obtaining block configured for accessing master files of production control system separately provided and obtaining product-related data in a bill of materials (BOM) data and process-related data in a work-process master;
a balance sheet storage block configured for storing a balance sheet as a reference;
an immediate journal entry block configured for referring to the production data obtained by the production data obtaining block, and immediately and sequentially journalizing transactions that relate to assets-related accounts in the material flow information obtained by the material flow tracking block until a most recent moment; and
a balance sheet update block configured for immediately and sequentially updating the balance sheet stored in the balance sheet storage block, by adding the new entry to the most recent result in the immediate journal entry block, thus generating the balance sheet for that updated moment as a real-time balance sheet.

2. The real-time balance sheet generating system according to claim 1, further comprising an immediate indicator calculation block configured for immediately calculating, based on the real-time balance sheet, a balance sheet quality (BSQ) value that is a performance indicator and is expressed by following equation (1),
BSQ =(M+R)/A+N/C (1)
where M is inventory assets, R is accounts receivables, A is total assets excluding cash, N is accounts payables, and C is total liabilities and shareholder's equity.

3. The real-time balance sheet generating system according to claim 1, wherein the balance sheet update block journalizes an amount of increase or decrease in each of today's inventory amount against a balance of a previous day's balance sheet, and stores a journalized result in a daily transaction file, as today's updated material transaction data, further comprising:
an operation transaction data obtaining block configured for obtaining today's purchase transaction data including today's occurrence and payment of accounts payable, today's sales transaction data including today's occurrence of accounts receivables and collection of price, and today's balance of payments data including today's deposit and withdrawal, and journalizing today's purchase transaction data, the today's sales transaction data, and the today's balance of payments data in accordance with on each of their own accounts to store a journalized result in the daily transaction file, as today's material transaction data;
a today's transaction journal entry block configured for journalizing the today's material transaction data and the today's operating transaction data stored in the daily transaction file, and storing journalized results in a today's trial balance transaction file; and
a today's financial statements generating block configured for generating a today's balance sheet, a today's income statements, and a today's cash flow statement respectively as financial reports of the day based on journal entry stored in the today's trial balance transaction file.

4. The real-time balance sheet generating system according to claim 3, further comprising a today's performance indicator calculation block configured to calculate a performance indicator supply-chain cash conversion cycle (SCCC) based on the financial reports of the day, which is expressed by a following equation (2),
SCCC=(M/Cₛ+R/S+P/Cₛ)·D (2)
where M is inventory assets, Cₛ is cost of goods sold, R is accounts receivables, S is sales, P is accounts payables, and D is an annual number of days.

5. The real-time balance sheet generating system according to claim 3, further comprising a financial statements conversion block configured to convert the today's financial statements into financial statements based on each of predetermined financial accounting standards.

6. A balance sheet evaluation system configured for calculating, based on an introduced balance sheet, balance sheet quality (BSQ) that is a performance indicator and is expressed by following equation (1),
BSQ=(M+R)/A+N/C (1)
where M is inventory assets, R is accounts receivable, A is total assets excluding cash, N is accounts payables, and C is total liabilities and shareholder's equity.

7. A working capital circulation velocity evaluation system configured for calculating, based on introduced balance sheet and income statement, a supply chain cash conversion cycle (SCCC) that is a performance indicator and is expressed by following equation (2),
SCCC=(M/Cₛ+R/S+P/Cₛ)·D (2)
where M is inventory assets, Cₛ is cost of goods sold, R is accounts receivables, S is sales, P is accounts payables, and D is annual number of days.
